(19) United States
(12) Patent Application Publication
(10) Pub. No.: US 2012/0145246 A1
(43) Pub. Date: Jun. 14, 2012

(54) SYSTEM AND METHOD FOR DISTRIBUTION OF REFRIGERANT TO A PLURALITY OF HEAT EXCHANGER EVAPORATOR COIL CIRCUITS

(75) Inventors: Horace Edgar French, Greensboro, GA (US); Darshan Shinde, Columbus, GA (US)

(73) Assignee: Heatcraft Refrigeration Products LLC, Stone Mountain, GA (US)

(21) Appl. No.: 13/311,326

(22) Filed: Dec. 5, 2011

Related U.S. Application Data
(60) Provisional application No. 61/422,609, filed on Dec. 13, 2010.

(51) Int. Cl. F15D 1/00; F28D 7/02; F28F 1/00

(52) U.S. Cl. 137/1; 165/177; 165/163; 137/561 R

(57) ABSTRACT

A refrigeration system comprising multi-output-port refrigerant distributor device. The device includes an input section, an output section and body portion. The input port is configured to be coupled to an expansion device of said system, and the output section has output ports each configured to be coupled to separate pressure-drop distributors of the system. The body portion is disposed between the input section and the output section. The body portion includes a passageway having an interior diameter which narrows in a direction from the input section towards the output section.

### CROSS REFERENCE TO RELATED APPLICATION

This application claims the benefit of U.S. Provisional Application Ser. No. 61/422,609, by H Edgar French on Dec. 13, 2010, entitled, “A SYSTEM AND METHOD FOR DISTRIBUTION OF REFRIGERANT TO A PLURALITY OF HEAT EXCHANGER EVAPORATOR COIL CIRCUITS,” commonly assigned with this application and incorporated herein by reference.

### TECHNICAL FIELD

This application is directed, in general, to refrigeration systems, and in particular to devices and methods for distributing refrigerant to evaporator coils of the system.

### BACKGROUND

The basic components of a refrigeration system include a refrigerant, a compressor, a compressor coil circuit, an expansion device, and an evaporator coil circuit. This system forms a loop through which the refrigerant flows. A typical refrigeration system may also include a plurality of evaporator coil circuits to provide additional cooling.

A refrigerant cycle, in operation, has a compressor that compresses a refrigerant. This compression raises the refrigerant's pressure and temperature. The refrigerant then flows through a condenser coil circuit to dissipate the heat of compression. After dissipating the heat of compression, the refrigerant flows through an expansion device. As the refrigerant flows through the expansion device it changes from a high pressure zone (prior to the expansion device) to a low pressure zone (after exiting the expansion device). In such fashion, the refrigerant evaporates and the temperature is reduced. The refrigerant then flows through an evaporator coil circuit, or alternatively multiple coil circuits depending on the application. Subsequently, the refrigerant flows from the evaporator coil circuit back to the compressor starting the refrigeration cycle again. The evaporator coil circuit, filled with cool refrigerant, provides the cooling effect by absorbing heat from the air and/or objects within the proximity thereof.

In conventional practice, the refrigerant is delivered from the expansion device to the evaporator coil circuit by means of capillary tubes, floats, and other types of metering devices to maintain a specific pressure drop throughout the evaporator coil circuit. Additionally, a distribution device with multiple passages is typically disposed between the expansion device and the evaporator coil circuit to further control refrigerant pressure and even distribution and flow to the evaporator coil circuit.

Certain applications require a greater cooling effect achieved with a refrigeration system that uses multiple evaporator coil circuits. In such refrigeration systems, each evaporator coil circuit is paired to a corresponding expansion device. In this fashion, a proper pressure is maintained in each separate evaporator coil circuit and a desired cooling effect is achieved. FIG. 1 is a schematic representation of a conventional refrigerant system incorporating multiple evaporating coil circuits 109 and 112 housed in an area to be cooled. Refrigerant tubes 101 and 102 carry a refrigerant into thermal expansion devices 103 and 104, respectively. Distributor tubes 105 and 106 allow the refrigerant to flow into distributors 107 and 110. Distributors 107 and 110 of the type including, but not limited to, a low pressure drop, or high pressure drop. Distributors 107 and 110 equalize pressure amongst capillary tubes 108 and 111 and allow refrigerant to flow into the evaporator circuit coils 109 and 112. One inherent problem with such multiple evaporator coil circuit systems, however, is a rising cost associated with: a plurality of expansion devices, installation, and maintenance thereof. Additionally, with multiple expansion devices, uniform temperature control can become problematic.

In an attempt to overcome such rising costs, a single expansion device may be coupled to a plurality of evaporator coil circuits. A single distributor is provided to equalize the amount of refrigerant flowing through it. In turn, this requires a complicated system of distribution tubes and passages to connect to multiple evaporator coil circuits. Further, long distribution tubes are required whereby each of the distribution tube lengths must measure the exact same to ensure adequate pressure and flow of the refrigerant to each evaporator coil circuit. Additionally, each evaporator coil circuit is required to have the same number of bends in the evaporator coils to maintain the proper pressure drop essential for proper refrigerant distribution. In most applications, such system could not be easily preassembled due to the varying handling and mounting requirements of each implementation, thus requiring the distribution tubes to be welded to the evaporator coil circuit either on the assembly line or in the field. Ultimately, this may result in loss of the necessary tolerance control for proper refrigerant distribution, potential leaks, as well as increased assembly costs.

Despite efforts to date, the need remains for an effective and cost efficient system and method for connecting multiple heat exchanger/evaporation coils to a single thermal expansion device. The present disclosure overcomes the deficiencies of prior attempts by providing a single distributor system and method thereof. These and other needs are advantageously satisfied by the disclosed systems and methods for refrigerant distribution to a plurality of evaporator coil circuits.

### SUMMARY

One embodiment of the present disclosure is a refrigeration system comprising multi-output-port refrigerant distributor device. The device includes an input section, an output section and body portion. The input port is configured to be coupled to an expansion device of said system, and the output section has output ports each configured to be coupled to separate pressure-drop distributors of the system. The body portion is disposed between the input section and the output section. The body portion includes a passageway having an interior diameter which narrows in a direction from the input section towards the output section.

Another embodiment of the present disclosure is a method distributing refrigerant through a refrigeration system. The method comprises supplying a refrigerant to the above-described multi-output-port refrigerant distributor device of the system.

Additional objects, advantages and novel features of the invention will be set forth in part in the description, examples and figures which follow, all of which are intended to be for illustrative purposes only, and not intended in any way to limit the invention, and in part will become apparent to those skilled in the art on examination of the following, or may be learned by practice of the invention.

### BRIEF DESCRIPTION OF THE DRAWINGS

For the purpose of illustrating the embodiments of the disclosure, there is shown in the drawings exemplary implementations; however, it is to be understood that this invention is not limited to the precise arrangements and instrumentalities shown. To assist those of ordinary skill in the art in making and using the disclosed systems and methods, reference is made to the appended figures, wherein:

FIG. 1 is a schematic representation of a conventional refrigerant system incorporating multiple evaporating coil circuits each associated with a separate expansion device;

FIG. 2 is a schematic representation of a refrigerant system according to one embodiment of the present disclosure including a single expansion device, a multi-output port distributor, a first distributor tube and a second distributor tube, a first evaporator coil circuit with a first pressure drop distributor, and a second evaporator coil circuit with a second pressure drop distributor;

FIG. 3 is a schematic representation of an example a multi-output port distributor, illustrating refrigerant flow there-through according to the present disclosure; and

FIG. 4 is a block diagram of a method for equally distributing refrigerant to multiple evaporator coils according to the present disclosure.

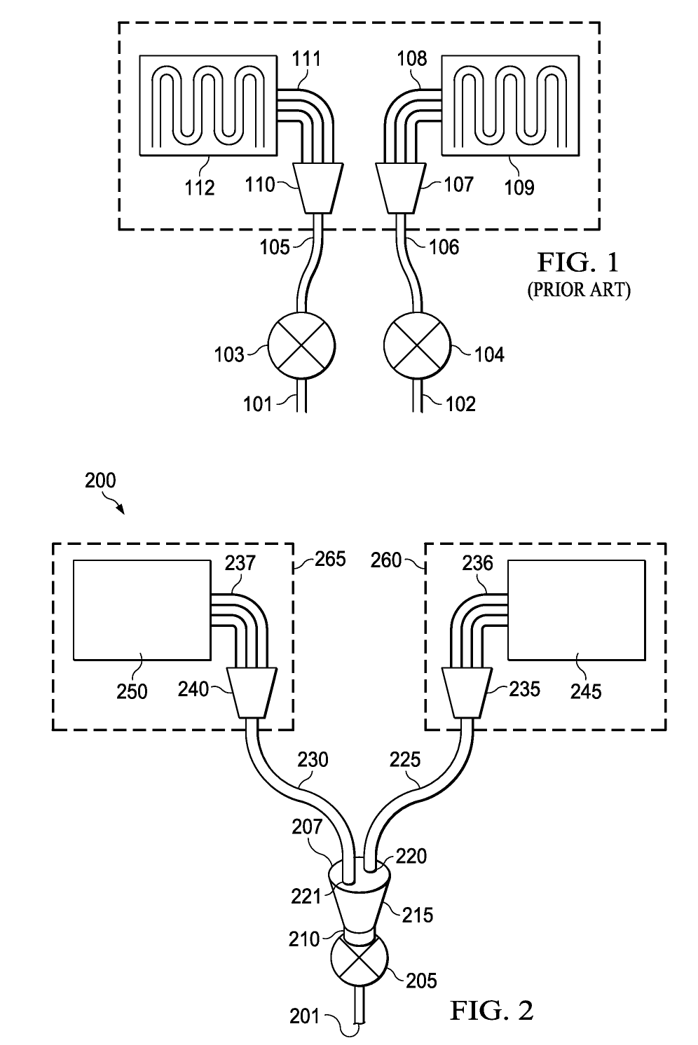

### DETAILED DESCRIPTION

The present disclosure provides for systems and methods for refrigerant distribution to multiple evaporator coil circuits of a refrigeration system. In particular, connecting the output of a multi-output port distributor to refrigerant distributors, as discussed below, facilitates control of the relative flow of refrigerant through the refrigerant distributors and on to the evaporator coil circuits.

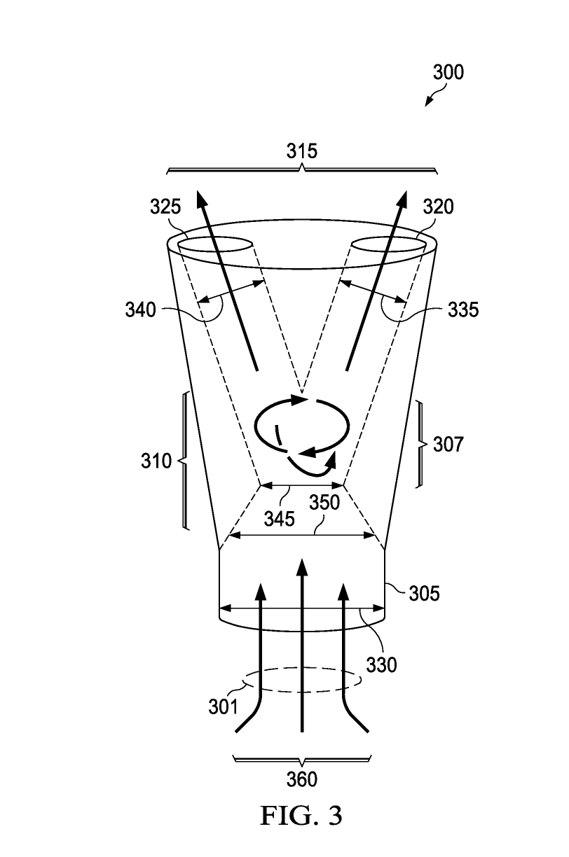

FIG. 2 illustrates an example embodiment of a refrigerant system 200 of disclosure, wherein a refrigerant 201 flows into an expansion device 205. From expansion device 205, refrigerant 201 flows into a multi-output port distributor 207. In some cases the distributor 207 can have internal passageways arranged in a Y-shaped configuration, such as shown in FIG. 3. The multi-output port distributor 207 includes at least a first output port 220 and a second output port 221, through which refrigerant 201 may be equally distributed.

In some embodiments of the system 200, a first evaporator coil circuit 260 and a second evaporator coil circuit 265 are in communication with first output port 220 and second output port 221, respectively. First evaporator coil circuit 260 has a first evaporator coil 245, a first refrigerant distributor 235, and a set of first capillary tubes 236.

In some embodiments of the system 200, the first refrigerant distributor 235 can be a pressure drop-type distributor. First pressure drop distributor 235 is in communication with first output port 220 and is disposed between first evaporator coil circuit 260 and first output port 220. Likewise, second evaporator coil circuit 265 has second evaporator coil 250, a second refrigerant distributor 240, and a set of secondary capillary tubes 237.

In some embodiments of the system 200, second refrigerant distributor 240 is in communication with second output port 221. Second refrigerant distributor 240 can be a drop-type pressure distributor. Second refrigerant distributor 240 is disposed between second evaporator coil circuit 265 and second output port 221.

Refrigerant 201 flows into expansion device 205 and is subjected to expansion, thereby cooling refrigerant 201. From expansion device 205, refrigerant 201 flows into input 210 of the multi-output port distributor 207. Next, refrigerant 201 is distributed amongst first output port 220 and second output port 221.

From first output port 220, refrigerant 201 flows to first pressure drop distributor 235 through a first distributor tube 225. Refrigerant 201 then flows through first pressure drop distributor 235 and then through a first set of capillary tubes 236 to first evaporator coils 245.

From second output 221, refrigerant 201 flows to second pressure drop distributor 240 through a second distributor tube 230. Refrigerant 201 then flows through second pressure drop distributor 240, and then through second set of capillary tubes 237 to second evaporator coils 250.

In some embodiments, first pressure drop distributor 235 and second pressure drop distributor 240 can be configured to equalize the flow and pressure of refrigerant 201. In some embodiments, first pressure drop distributor 235 and second pressure drop distributor 240 may, respectively at times, create backpressure in first distributor tube 225 and second distributor tube 230, as necessary, to equalize the flow of refrigerant 201.

In some embodiments, first evaporator coils 245 and second evaporator coils 250 are contained within the same chamber. That is, a single housing, called a chamber, contains both first evaporator coils 245 and second evaporator coils 250. However in other embodiments the first evaporator coils 245 and second evaporator coils 250 are contained within the separate chambers.

FIG. 3 shows one embodiment of a multi-output-port refrigerant distributor device 300 of the disclosure, and a refrigerant 301 flow through a passageway of the device 300 (arrows). In some embodiments, refrigerant 301 flows from an expansion device (not pictured) into an input port 305. The distributor device 300 can have a body portion 310 and an output section 315. Output section 315 has at least a first output port 320 and a second output port 325. Body portion 310 has a passageway that narrows in a direction from input 305 to output section 315.

In some embodiments, the passageway of body portion 310, in relation to input 305, is configured to create a Venturi effect at a vortex portion 307. Refrigerant 301 flowing through body portion 310 will therefore be subject to the Venturi effect which, in turn, increases the velocity of refrigerant 301 and forms a vortex at vortex portion 307. A result of the formation of the vortex is substantially equal distribution of refrigerant 301 to first output 320 and second output 325. For example, in some embodiments, flow of the refrigerant 301 to the first output 320 and the second output 325 are within about 1 percent or less, and in some cases within about 0.1 percent of less.

In some embodiments, a high velocity flow can facilitate substantially equal distribution refrigerant 301 to first output 320 and second output 325. In further embodiments, the vortex may be used in combination with a high velocity flow of refrigerant 301 can facilitate substantially equal distribution. In some embodiments, body portion 310 can be configured to cause severe, high velocity turbulence in refrigerant 301 flow to facilitate substantially equal refrigerant distribution to first output 320 and second output 325.

In some embodiments, input port 305 has an internal input diameter 330, first output port 320 has a first internal output diameter 335, second output port 325 has a second internal output diameter 340, and vortex portion 307 has an internal vortex diameter 345. The internal vortex diameter 345 may be less than the internal input diameter 330. Further, in some embodiments, the internal vortex diameter 345 may be less than the sum of the first internal output diameter 335 added to the second internal output diameter 340. That is, the total of the first internal output diameter 335 and the second internal output diameter 340 may be greater than the internal vortex diameter 345. Additionally, body portion 310 has an internal body diameter 350 that varies in size through body portion 310. The relationship between the first internal output diameter 335, the second internal output diameter 340, the internal vortex diameter 345, internal body diameter 350, and the input diameter 330 creates a desired Venturi effect.

The first internal output diameter 335 and the second internal output diameter 340 may be sized to ensure that the flow of refrigerant 301 through first output port 320 and second output port 325 is substantially the same pressure as refrigerant 301 leaving the vortex portion 307 and/or slightly less than refrigerant 301 flowing into the input port 305.

As illustrated in FIG. 3, in some embodiments, body portion 310 can include a passageway having an interior diameter 350 which narrows in a direction from an input section 360 (e.g., having the input port 305) towards, and in some cases to, the output section 315. As also illustrated, in some cases the interior diameter 350 continuously narrows from the input section 305 to a narrowest diameter 345 of the passageway. As further illustrated, in some cases different part of the passageway (e.g., the vortex portion 307), the interior diameter 350 continuously widens in a direction from a narrowest diameter 345 of the passageway towards the output section 315. In some embodiment the multi-output-port refrigerant distributor device 300 includes, or in some cases is, a Venturi flow distributor.

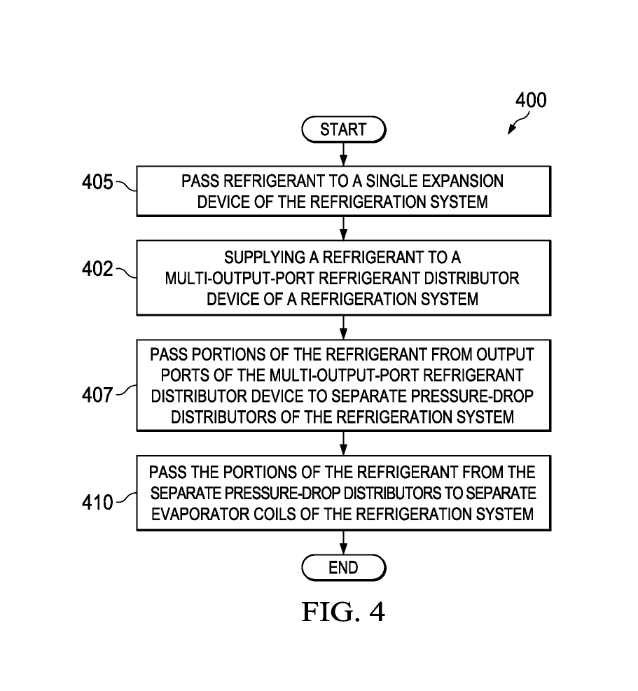

FIG. 4 discloses a method 400 of distributing refrigerant through a refrigeration system, such as any of the systems 200 discussed in the context of FIGS. 2-3. With continuing reference to FIGS. 2 and 3, in some embodiments of the method 400, in step 402, a refrigerant 301 is supplied to a multi-output-port refrigerant distributor device 300 of a refrigeration system 200.

Embodiments of the distributor device 300 can have an input section 360, a body portion 310, a vortex portion 307, and an output section 315, or other any of the other features such as discussed in the context of FIGS. 2 and 3. For instance, the body portion 310 can be disposed between the input section 360 and output section 315 and can have a passageway that-narrows in a direction from the input section 360 towards, and in some cases to, the output section 315. The output section 315 can have output ports (e.g., at least a first output port 320 and a second output port 325). Each output port 320, 325 can be configured to be coupled to separate pressure-drop distributors (e.g., pressure-drop distributors 235, 240) of the system 200, such as discussed above in the context of FIG. 2.

In some cases, the refrigerant 301 is passed, in step 406, to a single expansion device 205 of the system 200. The expansion device 205 can be fluidly coupled to the input port 305 of the input section 360, to facilitate supplying refrigerant to the distributor device 300 in step 402.

In some embodiments of the method 400, as part of step 402, the refrigerant 301 is equally distributed amongst the output ports (e.g., first output port 320 and the second output port 325).

In some embodiments of the method 400, in step 407, portions of the refrigerant 301 are passed from the output ports (e.g., ports 320, 325) to the separate pressure-drop distributors. For instance, the portions of refrigerant 301 in step 405 can be passed from the separate pressure-drop distributors (e.g., pressure-drop distributors 235, 240) to separate evaporator coils (e.g., coils 245, 250) of the system 200

In some embodiments of the method 400, in step 410, the portions of the refrigerant 301 from the separate pressure-drop distributors are passed to separate evaporator coils (e.g., coils 245, 250) of the system 200. For instance, a portion of the refrigerant 301 is passed from the first output port 320 through a first distributor tube 235 to the first evaporator coil 245 and another portion of the refrigerant 301 is passed from the second output port 325 through a second distributor tube 240 to a second evaporator coil 250. In some embodiments, the portions of the refrigerant 301 distributed to each of said evaporator coils (e.g., coils 245, 250) are substantially equal portions.

In some cases, the first evaporator coil circuit 260 can have a first refrigerant pressure distributor 235 and the second evaporator coil circuit 265 can have a second refrigerant distributor 240. In some embodiments, the first refrigerant distributor 235 and the second refrigerant distributor 240 may be pressure drop-type distributors. In some embodiments, the refrigerant flow 301 at the output section 315 of the distributor device 300 is equalized by a combination of the first pressure drop distributor 235 and the second pressure drop distributor 240.

In alternative embodiments, the output section 315 of the multi-output port distributor 300 may contain additional output ports configured in analogous fashion as the first output port 320 and the second output port 325. An embodiment of the method 400 that includes additional output ports also incorporates additional analogous components and functionality as associated with the first output port 320 and the second output port 325. Namely, additional output ports would be in communication with additional pressure drop distributors and additional evaporator coil circuits.

Additionally, with reference to the distributor device 300, the input 305 has an input diameter 330, the first output 320 has a first internal output diameter 335, the second output 325 has a second internal output diameter 340, the body 310 has an internal body diameter 350 and the vortex portion 307 has an internal vortex diameter 345. In some embodiments, preferably, the internal vortex diameter 345 is less than the internal input diameter 330. Further, the internal vortex diameter 345 may be less than the sum .of: the first internal output diameter 335 added to the second internal output diameter 340. That is, in some embodiments, the total of the first internal output diameter 335 and the second internal output diameter 340 may be greater than the internal vortex diameter 345. In some embodiments, the relationship between the diameter of each of the first internal output diameter 335, the second internal output diameter 340, the internal vortex diameter 345, internal body diameter 350, and the input diameter 330 creates a desired Venturi effect at the vortex portion 307. The first internal output diameter 335 and second internal output diameter 340 may be sized to ensure that the flow of the refrigerant 301 at the first output 320 and the second output 325 is substantially the same pressure as the refrigerant flow leaving the vortex portion 307, and/or slightly less than the refrigerant flowing into the input 305.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Accordingly, the present disclosure expressly encompasses such variations, modifications, and/or enhancements as would be apparent to persons skilled in the art from the disclosure provided herein.

What is claimed is:

1. A refrigeration system, comprising:
a multi-output-port refrigerant distributor device, including:
an input section having an input port that is configured to be coupled to an expansion device of said system,
an output section having output ports each configured to be coupled to separate pressure-drop distributors of said system, and
a body portion disposed between said input section and said output section, wherein said body portion includes a passageway having an interior diameter which narrows in a direction from said input section towards said output section.

2. The system of claims 1, wherein said interior diameter continuously narrows from said input section to a narrowest diameter of said passageway.

3. The system of claim 1, wherein, for different part of said passageway, said interior diameter continuously widens in a direction from a narrowest diameter of said passageway towards said output section.

4. The system of claim 3, wherein said passageway with said continuously widening interior diameter of is a vortex portion of said body portion.

5. The system of claim 1, wherein a narrowest diameter in said passageway is less than a combined sum of internal diameters of said output ports, and, is less than an interior diameter of said input port.

6. The system of claim 1, wherein said multi-output-port refrigerant distributor device includes a Venturi flow distributor.

7. The system of claim 1, wherein said multi-output-port refrigerant distributor device is configured to distribute a refrigerant flowing there-through substantially equally to each of said output ports.

8. The system of claim 1, wherein internal passageways of said multi-output-port refrigerant distributor device are arranged in a Y-shaped configuration.

9. The system of claim 1, wherein said multi-output-port refrigerant distributor device has a first output port and a second output port.

10. The system of claim 1, wherein said system has a single said multi-output-port refrigerant distributor device and a single said expansion device coupled to said input port of said single multi-output-port refrigerant distributor device.

11. The system of claim 1, further including:
a first evaporator coil circuit coupled to a first one of said output ports; and
a second evaporator coil circuit coupled to a second one of said output ports.

12. The system of claim 11, wherein a first evaporator coil of said first evaporator coil circuit and a second evaporator coil of said second evaporator coil circuit are housed in a same chamber

13. The system of claim 11, wherein said first evaporator coil circuit includes a first one of said pressure-drop distributors and said second evaporator coil circuit includes a second one of said pressure-drop distributors.

14. The system of claim 1, wherein each one of said pressure-drop distributors is in fluid communication with a separate one of said output ports through separate distributor tubes.

15. The system of claim 1, wherein a first one of said pressure-drop distributors is configured to create back pressure in a first distributor tube coupled to a first one of said output ports, and a second one of said pressure-drop distributors is configured to create back pressure in a second distributor tube coupled to a second one of said output ports, thereby causing a substantial equalization of a refrigerant flow through said output ports.

16. A method of distributing refrigerant through a refrigeration system, comprising:
supplying a refrigerant to a multi-output-port refrigerant distributor device of said system, said multi-output-port refrigerant distributor device, including:
an input section having an input port that is configured to be coupled to an expansion device of said system,
an output section having output ports each configured to be coupled to separate pressure-drop distributors of said system, and
a body portion disposed between said input section and said output section, wherein said body portion includes a passageway having an interior diameter which narrows in a direction from said input section towards said output section.

17. The method of claim 16, further including passing portions of said refrigerant from said output ports to said separate pressure-drop distributors of said system.

18. The method of claim 17, further including passing said portions of said refrigerant from said separate pressure-drop distributors to separate evaporator coils of said system.

19. The method of claim 18, wherein said portions of said refrigerant distributed to each of said evaporator coils are substantially equal portions.

20. The method of claim 16, further including passing said refrigerant to said input port of said multi-output-port refrigerant distributor device from a single expansion device.
